(19) United States
(12) Patent Application Publication
(10) Pub. No.: US 2008/0087017 A1
(43) Pub. Date: Apr. 17, 2008

(54) Van Nimwegen efficient pollution free internal combustion engine

(76) Inventor: Robert R. Van Nimwegen, Queen Creek, AZ (US)

Correspondence Address: ROBERT R. VAN NIMWEGEN, 470 W. TWIN PEAKS PKWY, QUEEN CREEK, AZ, 85243, US

(21) Appl. No.: 11/581,257

(22) Filed: Oct. 16, 2006

(51) Int. Cl. F02B 29/04

(52) U.S. Cl. 60/599

(57) ABSTRACT

Internal combustion engines, both compression ignition (CI) and spark ignition (SI), four cycle and turbocharged, are defined with the proposed patented modifications to improve environmental acceptability. Thermal efficiency has been more than doubled at the maximum power design point. The CI engine 75.8 percent and the SI engine 72.7 percent. The particulates (smoke), nitrus oxide, and carbon monoxide have been reduced to a trace for both engine types. With the improved thermal efficiency the carbon dioxide produced per horsepower is less than half of the current designs. Exhaust noise and obnoxious smell has been eliminated for both engine types. These predicted improvements are based on the use of existing fuels. A byproduct of the design will be the recovery of the distilled water resulting from the products of combustion.

A fuel tank is defined which collects the condensed water and varies the fuel storage volume to that required for the remaining fuel. With this design no empty space exists for the formation of fuel vapor which is an explosive safety hazard.

### BACKGROUND OF INVENTION

1. Field of Invention

Vehicular pollution is still one of the greatest dangers to our environment today. Studies have indicated that health is adversely affected to the extent that particulate pollution may be responsible for up to 60,000 deaths annually in the nation, more than the number of traffic fatalities. California clean air standards call for less than 50 micrograms per cubic meter per 24 hours, a standard three times more strict than the current federal standard.

This invention relates generally to internal combustion vehicular engines and more particularly to the Diesel Compression Ignition (CI) Engine, selected because of its inherently higher cycle efficiency and the desirable use of diesel fuel instead of gasoline. The CI engines higher compression ratio results in a more efficient cycle than the Otto Cycle Spark Ignition (SI) Engine. However, the specific power (horsepower/pound air per minute) has been limited by the introduction of smoke above a fuel-air ratio of greater than one half of the chemical optimum (stoichiometric). The SI engine is normally operated, to remain within acceptable operating temperature limits, with a fuel/air ratio greater than stoichiometric, resulting in the production of unacceptable hydrocarbons and carbon monoxide in the exhaust. Specific power of both the CI and SI engines is are creased with the addition of a turbocharger that increase the engine inlet air pressure and density, resulting in an increased flow of air, consequently, more power. Turbocharging increases the output power of the engine without the advantage of improving the specific power. Just with the addition of intercooling the air from the turbocharger will increase the inlet air density, providing an increase in the output power and improved specific power. These excellent performance features have made the CI engine the most desirable, economically, for commercial vehicles where fuel costs are influential in the selection process, however, because of the exhaust particulates and nitrous oxides, it has not resulted in the best selection for the environment. Even with a drastic limit on the fuel-air ratio the CI engines still smoke heavily at the higher power settings. Entrapped in the black smoke (particulates) are the hydrocarbons and aldehydes responsible for the obnoxious odors associated with trucks, busses, trains and aircraft. The elevated temperatures, existing during combustion, produce carbon monoxide by disassociation and nitrous oxides responsible for the formation of smog.

2. Description of Prior Art

It is known, in general, that the performance of internal combustion engines of all types are increased by introducing water and other non-fuels (such as tetraethyl lead) into the combustion chamber. The SI engines have usually introduced the water and the fuel during the lowest pressure portion of the cycle, during the intake stroke, prior to the start of the compression stroke. During the compression stroke fuel and water are vaporized with the increasing temperature and mixed uniformly with the air in the cylinder charge to form a combustible mixture. This mixture is ignited at the prescribed time by the spark plug, causing a flame front to move radially in all directions from the point of ignition. The flame front is also a pressure wave caused by the increased temperature resulting from the combustion behind this flame front. When the high pressure and radiation from the increased temperature of the fuel/air mixture ahead of the flame front reaches a critical value (that is a function of the octane number of the fuel), the mixture will auto-ignite (critical detonation), commonly referred to as “knocking” or “pinging.” This octane rating is increased by the fuel additives, such as lead, or by the addition of water which will control the maximum combustion temperature, keeping it below the critical detonation temperature. In this contex three different means of water addition are shown in the prior art, namely:
(1) direct injection of water into the combustion chamber (U.S. Pat. No. 4,408,573)
(2) introduction of vapor or air of high humidity into the intake passage upstream of the combustion chamber (U.S. Pat. No. 4,479,907);
(3) introduction of a mixing chamber in the intake passage where the fuel is mixed intensely and controlled just below the critical detonation temperature (U.S. Pat. No. 4,757,787).

The combustion of the fuel in a CI engine is entirely different from what has been described for the SI engine. During the compression stroke of the CI engine, only air and some non-combustibles, such as water, are in the cylinder to be compressed with a volume compression ratio (25:1 in the example shown in this invention), which is great enough to raise the air temperature above the “critical detonation” for the fuel used. Fuel is introduced at a selected time (crankshaft position) by an atomized spray, at a rate that has been adjusted to control the pressure rise in the combustion chamber. Oxidation (combustion) of the fuel occurs only in a zone surrounding fuel droplets where the fuel/air ratio is in the narrow range that will support combustion. Hydrogen will burn off first, leaving carbon (soot) if there is not sufficient oxygen to oxidatize all of the carbon, forming carbon monoxide and/or carbon dioxide. Experience has shown that above an equivalence ratio of 0.50 smoke is visible, increasing as richer mixtures are introduced.

Experience has shown improvement in the performance of CI engines by the addition of water, which is sprayed in the inlet (for example, U.S. Pat. No. 4,311,118) or introduced directly into the combustion chamber as a liquid when combined with the fuel forming a fuel-water emulsion (for example U.S. Pat. No. 4,412,512). However, the disadvantage of this system, particularly in small, high speed diesels, is that the emulsions have been proven to have a very short life and it is questionable whether the emulsion would remain stable, even long enough to permit it to enter the combustion zone. This disadvantage has been corrected by the proposed invention, which introduces the fuel and water by separate pumps and nozzles to control introduction times and quantity, mixing the fuel and water while vaporization is occurring and introducing it in a way that ensures intimate contact, allowing the complete oxidation of fuel to occur at all fuel/air ratios up to stoichiometric.

A study of prior art has shown that water injection into the inlet has been recovered from the exhaust by the use of the cryogenic oxygen as a heat sink for cooling the exhaust to temperatures low enough to condense the water vapor in the exhaust. For example, U.S. Pat. No. 3,672,341 is Air Pollution-Free Internal Combustion Engine and Method for Operating Same, which is unique in its design. Intake valves of the typical engine design are not required. A nitrogen free engine is proposed with cryogenic oxygen stored in pressure vessels, which is introduced to the cylinder as it starts the compression stroke, using only the amount required for stoichiometric combustion of the fuel used at the selected power setting. Since air is not used, nitrogen, which is considered inert to the cycle, does not have to be pumped, heated or cooled and it is not available for reaction with oxygen, forming NOX. During the exhaust stroke water is sprayed into the cylinder, flashing into steam, to cool the cylinder walls and piston. In a multicylinder engine this mixture will combine with the exhaust products, be cooled in a heat exchanger with cryogenic oxygen as the coolant. Disadvantages of this system will be the high cost and storage problems associated with the use of cryogenic oxygen. Another example of a prior art engine, with water injected after the exhaust stroke, is given in U.S. Pat. No. 4,736,715. This engine operates on a six-stroke cycle consisting of a four-stroke combination cycle followed by a two stroke steam cycle. The water injected for the steam cycle also is used to cool the engine. The intake air for the combustion cycle is supercharged and preheated before induction. The engine provides for ability to maintain a maximum combustion efficiency and a low fuel consumption rate through normal operating ranges because of a near-optimum preignition pressure at all power levels with the ability to vary the compression ratios between minimum and maximum power levels.

Prior art has been identified where fuel has been reformed to aid in the reduction of exhaust pollutants. In the first example, U.S. Pat. No. 4,003,204 describes an engine with a Rankin cycle secondary loop operating with the heat derived in the engine cooling system, plus the addition of exhaust heat used to drive a turbine-generator. This generator delivers DC current to an electrolysis cell in which water is decomposed by the electric current into its basic hydrogen and oxygen components. The oxygen is passed to the air intake, enriching the oxygen in the air entering the carburetors, while the hydrogen is conveyed to a second carburetor. These two carburetors are connected by a linkage operated manually or by a control pressure for varying the ratio of the two carburated fuels delivered to the engine. An air cooled condenser has been used to condense and allow recirculation of the Rankin cycle fluid.

The second example of prior art, which considers the reformation of fuel, is given in U.S. Pat. No. 3,717,129. This invention resides in passing exhaust gasses from an engine through a fuel regenerator in indirect heat exchange with fuel and steam in contact with a catalytic bed for reforming the fuel. The reformed fuel is brought into heat exchange relationship with the fuel and water entering the fuel regenerator and thereby operating the engine using this reformed fuel which lowers the amount of pollutant species discharging from the engine. By this method it appears that a portion of the waste heat in the exhaust is recovered as additional hydrogen reformed from the steam to produce the stated 24 percent increase in the work output from the isooctane fuel. An additional subject of prior art for the reduction of pollutants considers the use of a particle filter to remove particulate matter from the diesel exhaust. U.S. Pat. No. 4,702,075.

### OBJECTS AND ADVANTAGES

The object of this invention is to provide a highly efficient vehicular engine which has eliminated pollutants from the exhaust. The CI diesel engine cycle is most desirable because of its higher efficiency and with the modifications proposed by this invention, the specific power can be increased and the particulates (soot and smoke) will be eliminated from the exhaust. This invention introduces a means of reforming the liquid fuel sprayed into the precombuster (reformer) with steam formed when water is injected into the high temperatures existing in the reformer. Water is introduced as a coolant into the exhaust cooler 32 (Boiler) by a high pressure pump, driven by the turbocharger, capable of handling water and vapor. At the fuel injection point, shortly before TDC, approximately one third of the total charge of air is in the reformer. Fuel has been injected prior to the water by a prescribed delay to allow time for the initiation of combustion. The principle of reforming fuels has long been practiced in the manufacture of blue gas (water gas). A weight ratio of water to hydrocarbon fuel of 1.2 or larger has been found to be acceptable. Exhausts of current auto and truck CI engines operating on hydrocarbon fuels produce pollutants that include particulates, hydrocarbons, carbon monoxide, nitrous oxides, carbon dioxide as well as obnoxious smell and exhaust noise. This invention has considered each of these pollutants and has resulted in a design capable of providing a substantial reduction to all of these pollutants and is suitable for vehicular propulsion.

1. Particulates (soot, smoke, dust and small pieces of metal) will be reduced in the exhaust by the following means. Smoke and soot are formed by the incomplete combustion of the carbon in the fuel. In a CI engine the inlet air is compressed by a compression ratio of 25:1 resulting in a pressure of over 2000 psia and an air temperature in the reformer in excess of 2000° F. Fuel sprayed into the combustion chamber burns only around the surface of a fuel droplet where the fuel-air ratio falls within the narrow band required for combustion. Hydrogen burns first and if there is insufficient oxygen remaining locally to convert the carbon to carbon monoxide and carbon dioxide, free carbon will remain as soot and smoke. Visible smoke appears when the fuel-air ratio is equal to, or exceeds, 50 percent of stoichometric. In the proposed invention high velocity water will be injected at approximately the same time as the fuel, physically and intimately mixing to assist in the completion of the chemical reaction. Because of the high temperature existing in the reformer at the time of injecting the water it will flash into steam, disassociating into hydrogen, oxygen and water vapor, providing the additional oxygen required for the complete oxidation of the carbon, preventing the smoke from forming. The water acts as a catalyst during the combustion process and is condensed, removed and recovered from the exhaust. In the process of condensation water droplets will neucleate on any existing solid exhaust particles and will be removed by the water separator.

2. Hydrocarbons, in some instances, result from unburned fuel spray hitting a cooled cylinder wall forming deposits on the combustion chamber walls. This invention proposes that the external wall of the reformer be coated with an insulator, zerconimum oxide, to limit heat transfer to the coolant, resulting in a higher temperature of the wall surface which is exposed to the vaporizing fuel and water. Transient thermal analysis has shown sufficient thermal inertia in the wall of the reformer that will maintain acceptable wall temperatures while cyclic gas temperatures encountered during intake, compression, combustion, expansion, exhaust and scavenge cycle. Since all liquids have been converted to gasses in the reformer there will be no contact of liquid fuel with the cooled cylinder walls, eliminating this mechanism for hydrocarbon formation. The fuel-air ratio of the proposed CI engine will not exceed stoichiometric. This excess fuel, with out special treatment, will result in the formation of hydrocarbons in the CI engine exhaust.

3. Carbon monoxide is the product of incomplete combustion found normally in the exhaust of a fuel rich burning SI engine and also as a result of the disassociation of carbon dioxide at the high temperatures encountered during normal operation of the CI engine. In the four-cycle CI engine the mixture of the scavenged air with the exhaust air in the exhaust manifold will reduce the exhaust temperature significantly, but not uniformly. For the CI engine cycle proposed this oxygen rich exhaust mixture will pass through an exhaust heat exchanger before being expanded through the turbocharger turbine. This process will allow ample time and an environment of reduced temperature for all of the carbon monoxide to react with the oxygen present, completing reaction of the remaining fuel, forming carbon dioxide.

4. Nitrous oxide is formed when the combustion temperature in the engine cycle exceed 1540° F. at an amount proportional to the temperature of the mixture. In the four-cycle CI engine the high exhaust temperatures are mixed with scavenge air from other cylinders, causing additional reactions which will result in modified exhaust products and a mixed average temperature. Because of the possible striations in temperature of the mixed exhaust it is difficult to predict the amount of nitrous oxide remaining in the exhaust. The proposed invention introduces an exhaust heat exchanger to cool this mixture to approximately 683 F, this cooling allows further reaction to occur and ensure that the minimum amount of both NO and CO are left in the exhaust. The expansion of the exhaust across the turbocharger turbine will provide the work to drive the compressor consequently reducing the temperature to near 347 F before entering the condenser. Additional cooling by passing ambient ram air through offset cooling fins will result in the condensation of a majority of the water from the humid exhaust.

5. Carbon dioxide is one of the products of combustion for hydrocarbon fuels and its amount in the exhaust is related directly to the amount of fuel burned. It is not considered a pollutant but it is responsible as a contributor to global warming because of the “green house effect.” Increasing the thermal efficiency of the proposed design and the specific power of the engine will result in a reduction of carbon dioxide by one half for the proposed design for the same vehicular power required.

6. Smell of the diesel exhaust is obnoxious. Hydrocarbons and aldehydes originate in regions where the flame is quenched by the cooled walls and where excessive dilution with air providing cooling and preventing the combustion process locally from either starting or going to completion. Members of the aldehyde family are believed to be responsible for the acrid odor of the CI engine exhaust. The amount of aldehydes in the CI engine exhaust is small, being less than 31 parts per million, but concentrations much less than this are irritating to the nose and eyes (of the order of one part per million). By reforming the fuel in a high temperature zone the formation of hydrocarbons and aldehydes will be eliminated as an undesirable exhaust product and source of obnoxious smell.

7. Exhaust noise is proportional to the eighth power of the gas velocity. The exhaust heat exchanger, turbocharger and condenser will significantly reduce the gas temperature to near ambient and consequently the specific volume of the exhaust, resulting in reducing discharge velocities to the low subsonic range.

### BRIEF DESCRIPTION OF THE DRAWINGS

FIG. 1. is a Schematic Drawing of the proposed CI Diesel Engine Cycle system and their relationship provide a clean high performance vehicular engine. A typical engine crossection, Reformed Diesel Engine 46, is shown with Fuel Pump 50, and Inlet Water Manifold. Air flow into the engine through a filtered air inlet to the Turbocharger 34 to increase the inlet pressure to 3 times ambient and maintains control of the temperature by passing it through an Inlet Cooler 30. The engine operates at a cycle pressure ratio of 25 to one. Exhaust from the engine is discharged into an Exhaust Heatexchanger 32 the water is heated to 1000 F (acting as a boiler). The cooled exhaust is then expanded through the Turbocharger 34 turbine to a reduced temperature of 346.5° F. and 26.3 psia pressure. Exhaust from the turbocharger enters the Water Condenser 90 to remove the heat of vaporization from the mixture of steam and exhaust products and collects the condensed water returning it to the Combined Water and Fuel Tank 94. The high pressure steam from the exhaust heatexchanger enters the Inlet Water Manifold for delivery to the cylinders with an electronic control system. The engine is designed to operate in the diesel mode and also a bottoming steam cycle mode. Power output in the diesel mode is 313.3 horsepower at a specific fuel consumption of 0.1583 lb/hp-hr. The steam engine cycle provides an additional output of 330.3 horsepower.

The engine cross-section shown is assumed to be a four cycle, six cylinder Mercedes 200D type engine with a modified Garrett Turbocharger. Analysis considered an engine with a bore of 3.710 inches and a stroke of 3.937 inches. The drawing illustrates a two valve per cylinder, but modern design would incorporate a four valve per cylinder system.

A secondary water system is shown on the schematic. The engine cooling system operates on a second water supply. Radiator 20 is a conventional air cooled radiator with an integral water tank. This system provides the cooling for the Inlet Cooler 30 and the water cooled engine system. Storage of the cooling water is in the Bottom Tank 24.

The water pump is a high pressure design that is geared to the Turbocharger 34 shaft and is capable of providing a water flow of 50 lbs/min at 2000 psi to the Exhaust Cooler (Boiler) 32 entering at 60 F and discharging at 1000 F.

FIG. 2 Psychrometric Chart of the Steam Cycle illustrates the highly efficient Rankine Cycle which is used by the electric power industry. Steam is provided at 1000 F and 2000 psia, which includes 370 F of superheat, to the prime mover driven generators. Experience has shown that a thermal efficiency of 45.7 percent is feasible. The intake valves will remain closed during scaveng portion of the cycle, allowing the steam to pressurise the cylinder and operate as a steam engine. Based on the second law of thermodynamics 330.3 horsepower will be generated with the steam available. Water enters the Exhaust Cooler 32 (Boiler) A at 60 F and 2000 psia and is discharged, as superheated steam at K 1000 F. The steam is expanded by the piston (CPR 25:1) and the turbocharger turbine to 346.5° F. and 26.3 psia at G. Passing through the Water Condenser 90 water will be condensed and removed depending on the efficiency of the ram air cooling. The condensed water is then drawn off and returned to the Combined Water And Fuel Tank 94.

FIG. 3. Shows a Duel Fuel and Water Injector with Reformer 86. This figure illustrates the mechanical design modifications introduced by the invention to make this a dual fluid injector to the reformer. An additional Water Attachment Fitting 82 has been added introducing a Water Inlet 66 line to the injector. A distribution passage through the housing will deliver the water to the Pintle 74. The Pintle 74 has a central passage and nozzle to direct a central water spray into the reformer. A glow plug, if required, is shown which does not influence the invention, but is desired to assist in the cold starting of the diesel engine. The mechanical arrangement of the reformer is illustrated.

FIG. 4. shows the Fuel Reformer 86. This figure illustrates the flow patterns as the fuel and water are injected into the reformer. Fuel is injected initially encountering a delay before combustion is started by autoignition, followed shortly by the water spray. The water flashes into steam at these temperatures, controlling the peak temperatures in the reformer and disassociating into hydrogen, oxygen and water vapor. Products of the chemical reaction pass through the radial passages in the fins and through the axial conical to the showerhead. Thereby, directed through a multitude of discharge orficies, designed to distribute the products uniformly into the cylinder cavity where it will undergo a secondary combustion of the hydrogen and carbon monoxide. This combustion will occur during the expansion stroke as long as combustible products are available.

FIG. 5 Detail Exhaust Condenser. The exhaust condenser is very important to the proposed cycle since it has been designed to reduce the exhaust temperature from 346.5 F to below 200° F. removing the heat of vaporisation and condensing the water vapor in the exhaust. The cooling is at ram velocity and at 60 F passing through the offset aluminum fins at the outer diameter of the condenser duct. The spherical aluminum plates are pierced and flanged to provide a maximum exposed surface to the exhaust products. The specific volume of the exhaust drops significantly as consensing occurs, reducing the velocity of the exhaust. The spherical shape is designed to trsp the condensate, collection it in a tube at the bottom of the duct. The concentrate will then be pumped into the dual fuel tank. The recovered water is distilled and will be recirculated indefinately. Since about ten percent of the products of combustion is water, about 9.8 pounds per hour will be added to the tank.

The drop in pressure across the condenser, as a result of the condensation of the water vapor, will increase the pressure drop across the offset cooling fins and acting as a jet pump will increase cooling air flow. The low velocity of the exhaust at the outlet will result in a very low noise level.

FIG. 6 The fuel tank is designed to store both the fuel and the water. A flexible elastomeric kevlar bellows is used to provide a variable volume for the fuel tank. As the fuel is used additional space becomes available for the 9.8 lbs/hr of water, condensed from the products of combustion, of the fuel while operating at maximum power. Water surrounds the flexible fuel storage to eliminate space for a fuel vapor to form. A major problem in vehicular accidents is the ignition of the fuel vapor, causing an explosition and fire.

A siginificant storage is required for the water of the steam engine portion of the cycle, resulting in the use of up to 49.27 lb/min at maximum power. All of the water in the steam cycle will be condensed and resuable. The water from products of combustion will be added to replace any leakage or drained at refuling time for other uses. Distilled water is sold today at about half the price per gallon of diesel fuel.

FIG. 7 Exhaust Products Variation With Exhaust Cooling. This curve shows cylinder combustion products as a perceentage of the flow, versus exhaust products temperature. This plot of the calculated combustion products in the cylinder, as a percentage of the weight of the fluid in the cylinder. The data covers the period from ignition through the completion of the expansion stroke and the opening of the exhaust valve. Engine speed was 3750 RPM, FA was equal to 0.50 and FW was equal to 1.20. of the twelve properties calculated seven were plotted, namely CO, CO₂, H₂O, H₂, OH, NO and O₂. The results of the analysis show how the NO, OH and CO are reduced drastically by the cooling in the heat exchanger. An additional reduction in gas temperature is made as the exhaust pressure is reduced as it passes through the turbocharger turbine, thereby, providing the work required to drive the compressor. At this point the temperature is near ambient, causing a portion of the water vapor to condense before entering the condenser to complete condensation and returning the condensate to the storage tank.

### PREFERRED EMBODIMENT—DESCRIPTION

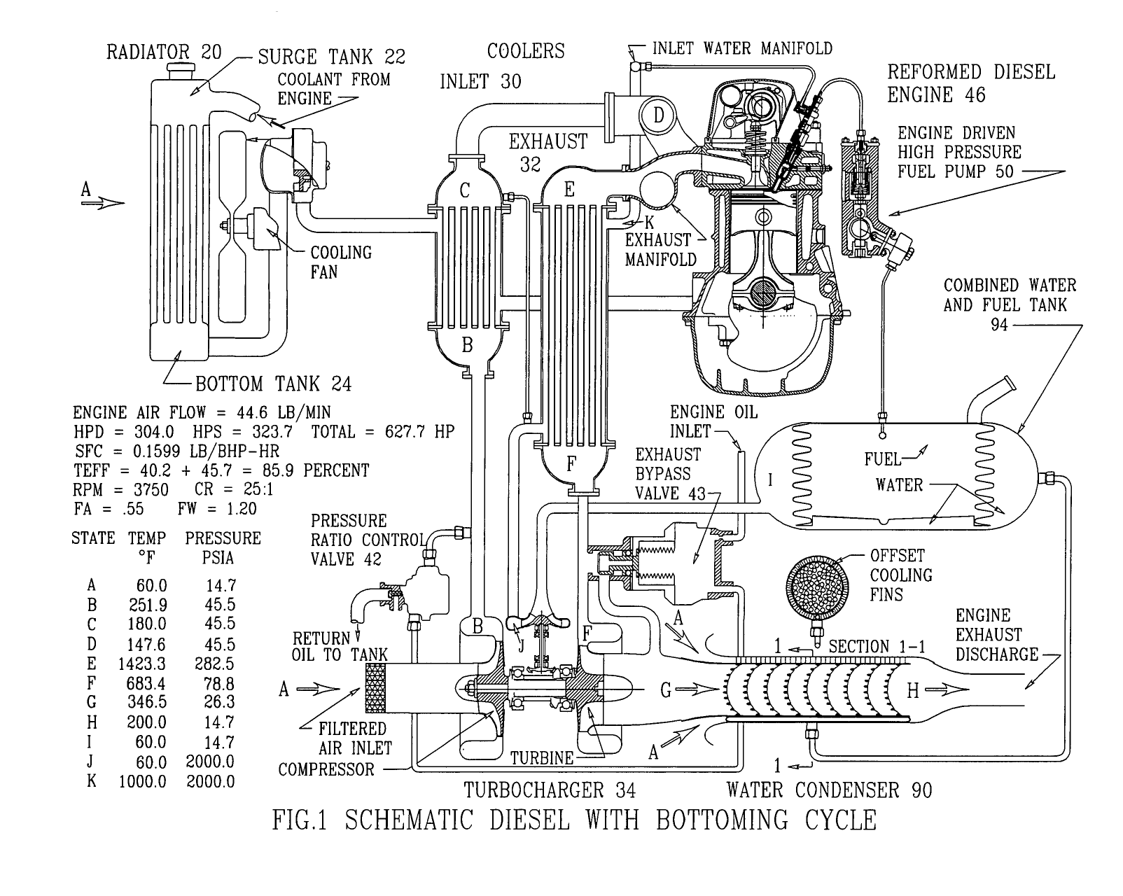

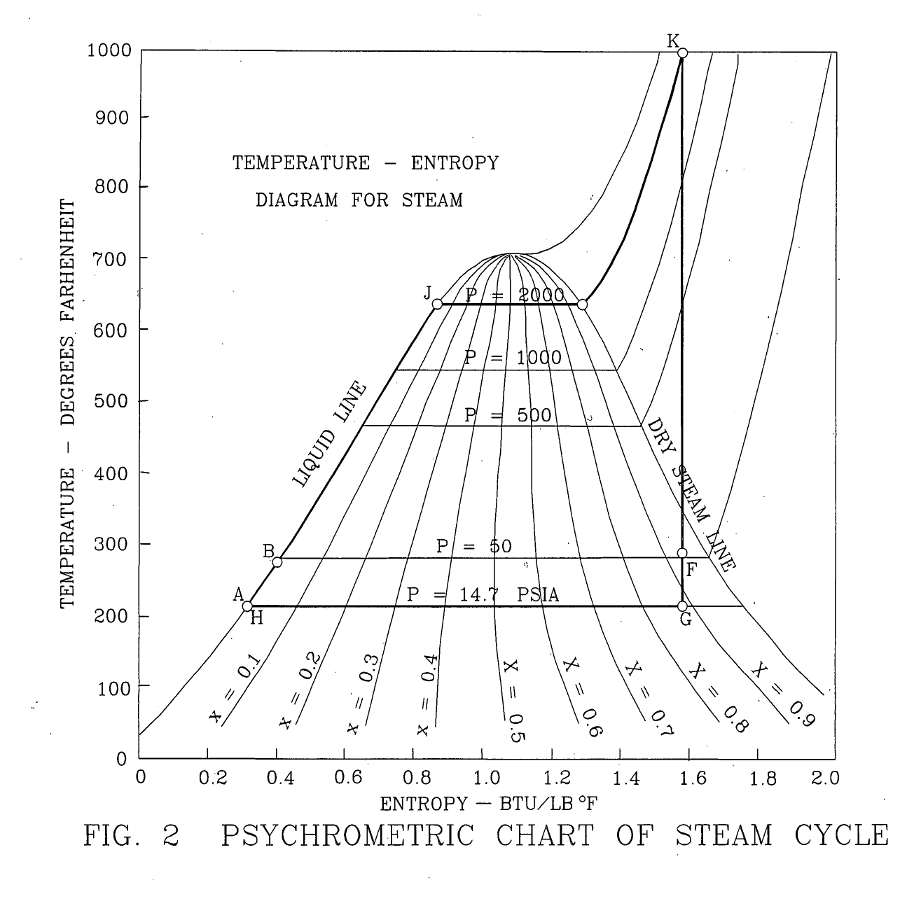

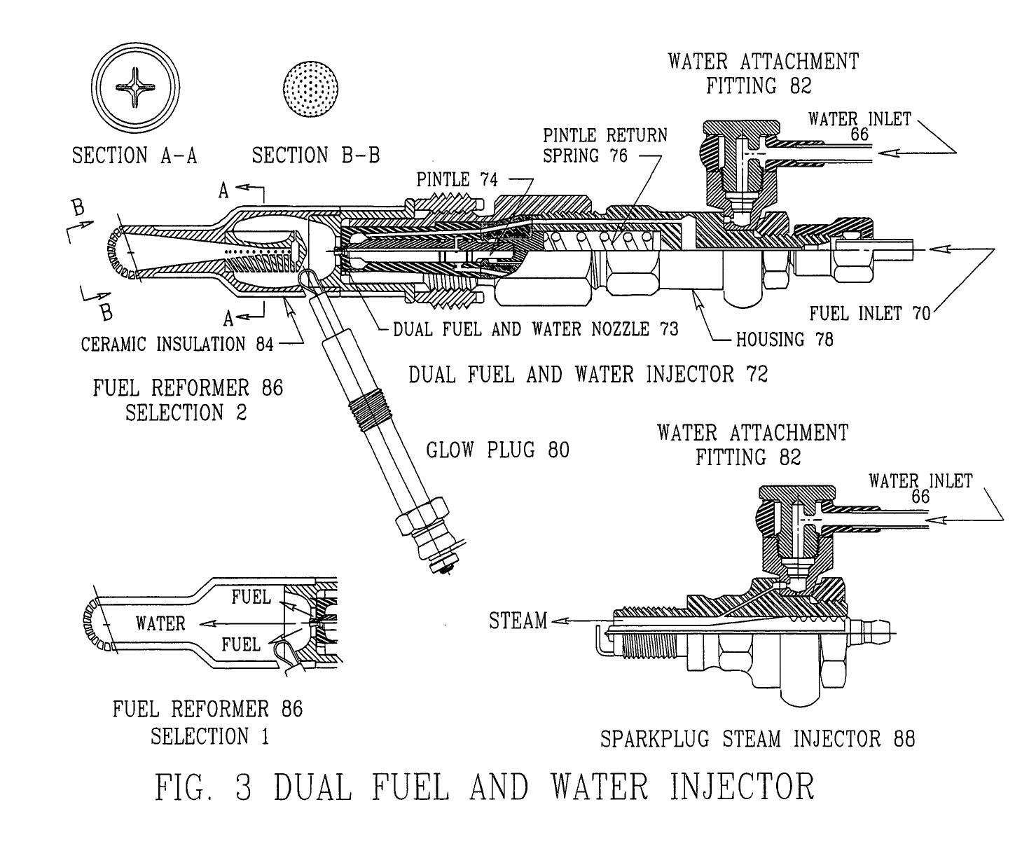

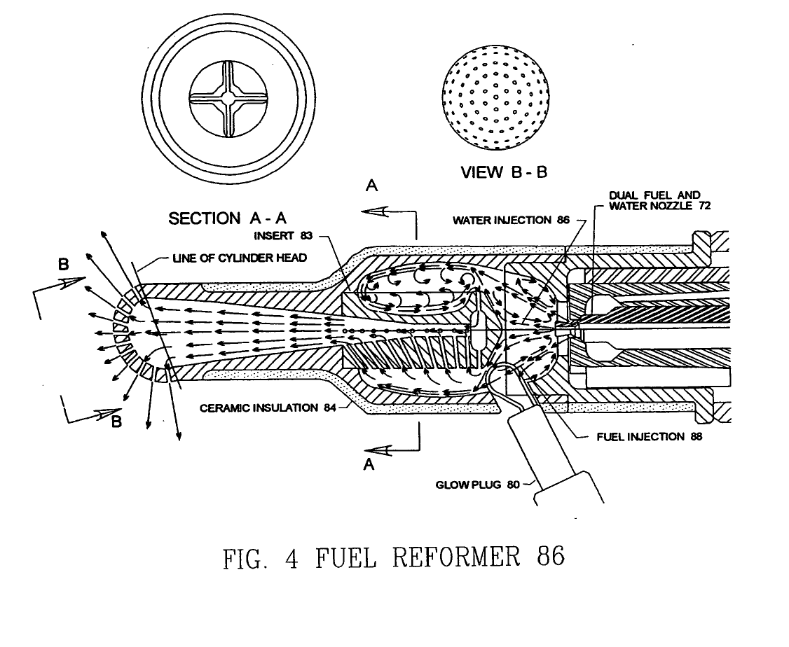

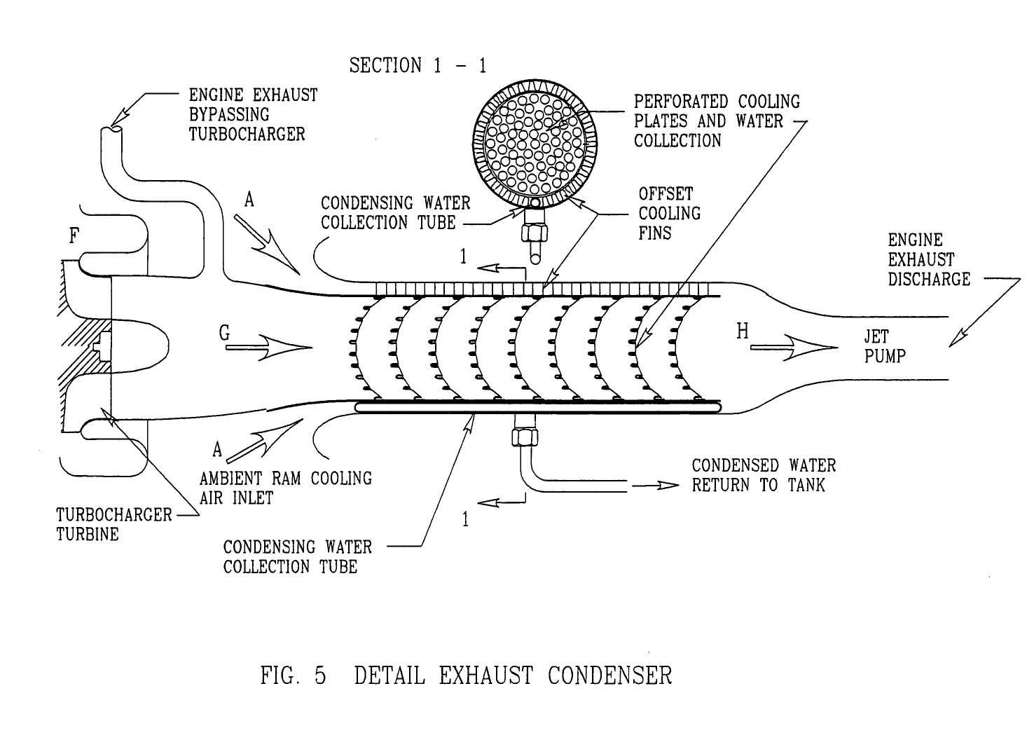

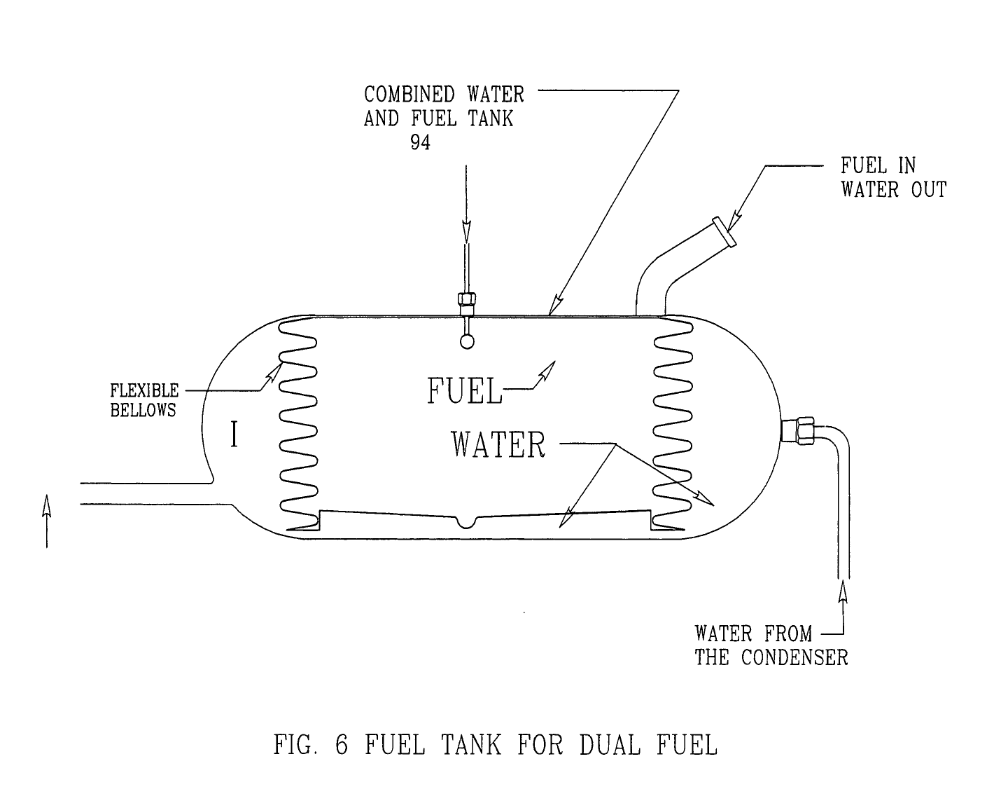

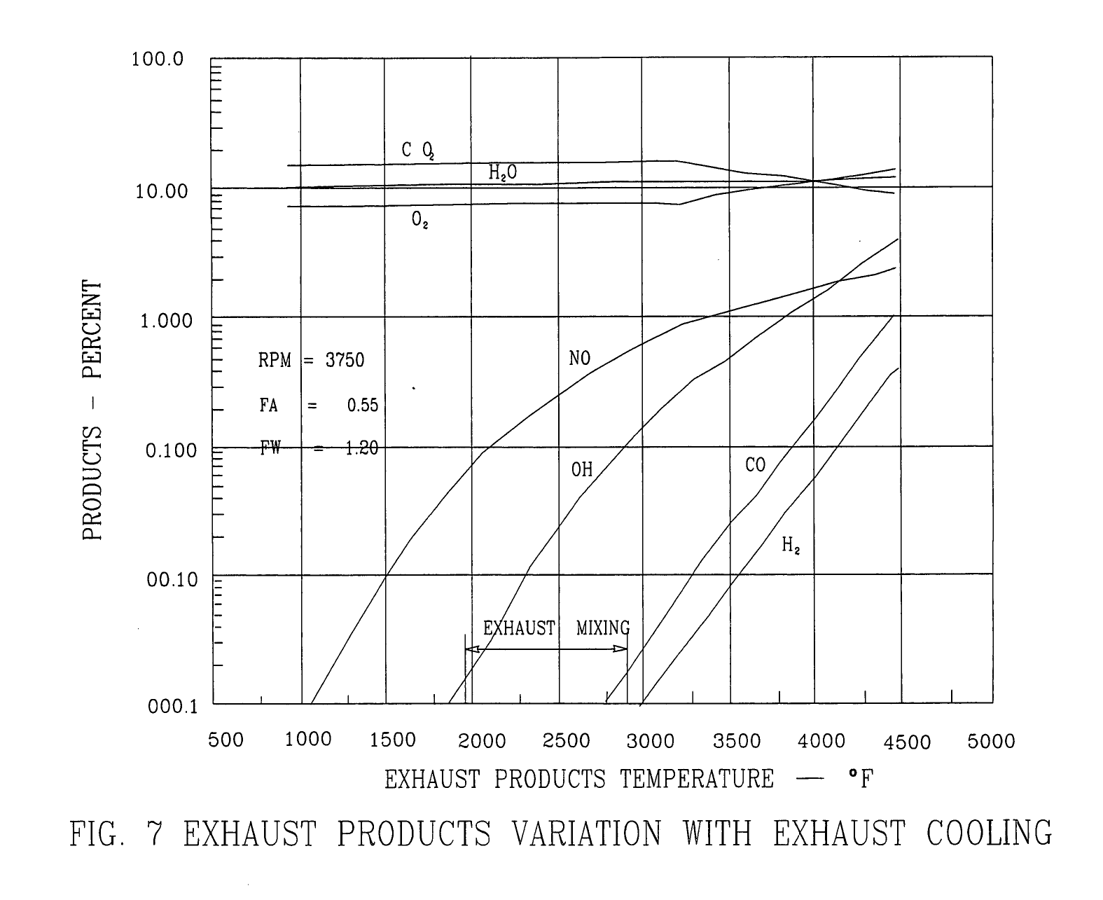

FIG. 1. is a Schematic Drawing of the Compression Ignition Engine Cycle. This drawing illustrates the mechanical components and their physical relationship in the operation of the engine. The radiator 20, is an assembly of the surge tank 22, cooling fins 23, and the bottom tank 24. A coolant fan 26, draws the cooling air over the cooling fins 23. Coolant from the engine enters the top of the radiator and is drawn from the bottom by the coolant water pump 28 and is directed into the inlet cooler 30, to the exhaust cooler 32 and into the internal cooling passages of the reformed diesel engine 46, and the cooled exhaust manifold 33. The engine airflow is drawn into the turbocharger 34, through an inlet air filter 40, State A and into the compressor 36. The air pressure ratio across the compressor 36, is controlled by regulating the amount of air bypassing turbine 38. The amount of this bypass air is controlled by the exhaust bypass valve 44, with the power to modulate this bypass control valve provided by the engine oil, bypass control pressure is regulated by the pressure ratio control valve 42, discharge oil from the control pressure ratio valve is returned to the engine oil tank 45. Compressed air from the turbocharger compressor, State B, is cooled by the inlet cooler 30, State C and is then delivered into the intake manifold 47. Additional compression of the air occurs during translation of the piston 45, represented by State D, of the reformed engine 46, in the manner conventional to the operation of an internal combustion engine. Fuel is introduced by means of the injector 72, supplied through a fuel inlet line 70 and a water inlet line 66, that are internally connected within the injector 72. The fuel and water are supplied at the pressure required for injecting liquids into the cylinder by the engine driven high pressure fuel and water pumps 50. Fuel is brought to the pumps from the fuel portion of the tank and water from the portion of the water tank 94, by the supply pumps 58, State E. After combustion and expansion, exhaust air leaves the engine through the cooled exhaust manifold 33 and enters the exhaust cooler 32. The cooled exhaust air, State F enters the turbocharger and a controlled portion passes through the turbocharger turbine 38, State G. The speed of the turbocharger is controlled by bypassing turbine air not required to maintain the desired pressure rise across the compressor. The remaining bypassed air is routed to the exhaust discharge. Turbine air is expanded, passing through the turbine 38 and cooled to near ambient temperature in the Condenser 90. When cooled to this lower temperature, water vapor in the exhaust will condense, forming the equivalent of rain in the discharge, State H. The water condenser 90 will be designed to remove the liquid water from the exhaust and by means of a water scavange, returning this water to the storage tank, where it is available for recycling to the engine.

FIG. 3. shows the Dual Fuel and Water Injector with Fuel Reformer. A modified water attachment fitting 82, has been added to the housing 78, of the injector 72, to provide a means of attaching the water inlet 66 line and connecting it to a passage which is provided to deliver this water to an annular distribution space around the pintle 74, to allow the water to enter the pintle through radial holes connected to a central passage in the pintle 74, this passage provides the means for delivering the water to an orfice nozzle on the center line at the tip of the pintle 74, generating the water spray entering the reformer 86. The fuel inlet 70, line introduces the fuel to a passage through the housing 78, to an annulus area surrounding the end of the pintle 74. Fuel pressure acting on the end of this pintle will retract the pintle 74, against the pintle return spring 76, allowing a conical spray of fuel to enter the reformer through the dual fuel and water nozzle 73. The glow plug 80, is shown to illustrate how it can be incorporated into the design to provide the additional heat required for cold starts of the diesel engine.

FIG. 4. shows the Fuel Reformer 86 giving a cross sectional detail of the reformer mechanical design, consisting of a two piece casting, insert 83, which has been diffusion bonded to form one integral part, the reformer 86. The outer surface has been plasma coated with a ceramic insulation (zirconium oxide) to limit the amount of heat that can be transferred to the cooled wall of the supporting structure. The water spray from the central nozzle will impinge on the end of the insert 83, and be deflected in a radial direction to contact the outer walls of the reformer 86. As fuel pressure rises the pintle 74 retracts causing an annulus orfice to open and introduce a conical spray of fuel. Initial combustion will occur on the inner and outer edge of the spray with the remaining liquid striking and traveling along the outer wall of the reformer. The high temperature within the reformer and the wall temperature accelerates the evaporation of both fuel and water. The four radial fins of insert 83, have a series of radial holes to direct the products of combustion to flow into a central conical passage, this difussing passage directs the flow to the shower head with an opening to the cylinder through a hole pattern shown in View B-B. As seen by this view, a majority of the holes are in the outer periphery of the elipsoidal shape. During the combustion period when the combustion products are being passed into the cylinder, the piston 45, will be close to the line of the cylinder head, and the majority of the flow of combustion products will be distributed uniformely into this cavity to mix with the remaining air and support the secondary combustion. The mass of the reformer is greater than ten times the mass of the combustion products, consequently the resulting high thermal inertia, the cyclic flow of the inlet and scavenge air with the combustion gases and the heat required for the vaporization of both the fuel and water are balanced to provide acceptable reformer operating temperatures.

### Operation—Main Embodiment

FIG. 1. is a Schematic Drawing of the Compression Ignition Engine Cycle. This is a cycle definition used for the performance analysis of the internal combustion engine as concieved for this invention with turbocharging, intercooling, precombuster (reformer), two cycle operation, exhaust cooling with a water seperator in the exhaust followed by two cycle as a steam engine. An extensive analytical analysis of each of the components is required to arrive at a selection for the optimum engine to be used for a specific vehicular design. Many variables can be studied to understand their influence on reducing the pollutants discharged into the environment. In the example to be presented, the turbocharger compressor pressure ratio, the diesel compression ratio, intercooling, FA ratio and exhaust cooling will be discussed. The cycle analysis consists of the following eight designated state points. From ambient condition to State A, represents the predicted pressure drop across the inlet filter, which can vary considerably in some applications by the dust environmental filter requirements. Pressure and temperature changes from State A, to State B, represent the design pressure ratio and the efficiency of the turbocharger compressor. Changes of conditions from State B, to State 3, represent the amount of intercooling and the resulting pressure drop across the heat exchanger. State C, represents the conditions entering the engine and will remain constant during each analysis, while State D, will vary as a function of the crank shaft angle. The crank shaft 49, is shown with the piston in the TDC position (top dead center), or 180 degrees. The CPR (compression ratio) is the ratio of the cylinder cavity volume at BDC (bottom dead center), zero degrees by the cavity volume at TDC. This is a volume relationship, not pressure. Thermodynamic properties are determined at each degree of crank shaft rotation.

Combustion (oxidation of both carbon and hydrogen) will occur in both the reformer and the cylinder cavity, with the combustion continuing in the cylinder until the exhaust valve opens at 308 degrees. The mass flow of air is nearly doubled in passing from exhaust discharge, combined with scavenge steam from an adjacent cylinder, mixing, resulting in a mixed average temperature at State E. In moving from State E, to State F, the pressure changes because of pressure drop across the exhaust cooler and the temperature changes by the amount of cooling produced in the heat exchanger. The turbocharger pressure ratio is controlled by the operation of a bypas valve that bypasses excess air (not required to maintain the speed required to provide the desired pressure ratio across the compressor) around the turbine, discharging it into the exhaust up stream of the water seperator. As the performance of the engine is increased by the addition of water and higher FA ratios an excess of energy is available in the exhaust. Water injected radial aircraft engines and research adiabatic diesel engines have used a power recovery turbine compounded with the turbocharger to recover this energy. This invention proposes using steam generated by the exhaust cooler and enjected acting as a steam engine cycle. Moving from State G, to State H, the exhaust temperature has been reduced to 346.5° F. by the turbine work, will make it possible for the condensation of the water vapor in the exhaust. This condensate will be trapped by the water seperator and with the scavenge water pump 92, will be returned to the tank to be recycled.

Since one of the products of combustion is water (about an amount equal to about 9.8 lbs/hr of distilled water) a significant amount of pure water would be obtained. Diesel engine power has been limited by the rate of combustion which controlled the maximum engine speed. With the intimate mixing of the fuel and oxidizer of this invention and the dual combustion zones the piston speed can be increased, with efficient combustion, resulting in higher output power.

### Analytical Approach

To analyze the effects of the addition of water to the diesel cycle, the chemical formula for the reaction during combustion has been modified as follows:

$$Fuel \qquad Air \qquad Water$$

$${x}_{13} [ {C}_{n} {H}_{m} {O}_{l} {N}_{k} + \frac{n + m / 4 + l / 2}{FA} ( {O}_{2} + 3.7274 {N}_{2} + 0.0444 Ar ) + \frac{FW \times MWF}{MWW \times SG} ( {H}_{2} + {O}_{2} / 2 ) ] \to {x}_{1} H + {x}_{2} O + {x}_{3} N + {x}_{4} {H}_{2} + {x}_{5} OH + {x}_{6} CO + {x}_{7} NO + {x}_{8} {O}_{2} + {x}_{9} {H}_{2} O + {x}_{10} {CO}_{2} + {x}_{11} {N}_{2} + {x}_{12} Ar$$

FA=Fuel/Air Ratio FW=Fuel/Water Ratio MWF=Modal Weight Fuel MWW=Modal Weight Water SG=Specific Gravity Fuel
   The above equation has thirteen unknowns, five more equations are obtained from the atomic balance equations of carbon, hydrogen, oxygen, nitrogen and arogon. Six dissociation equilibrium reactions are included and the thirteenth equation required is the energy equation, which for the steady flow process states that the energy of the reactants is equal to the energy of the products. With these thirteen equations defined the unknowns are determined at each degree of rotary motion of the crankshaft. The amount of heat added at each shaft rotation increment is dependant on the amount of carbon that is converted to carbon monoxide and carbon dioxide and the amount of hydrogen that has been converted to water vapor.

### EXAMPLE

A modification of the Mercedes Benz 200d, with a Garrett turbocharger, was selected as an example for a CI automotive engine that could be used for the analytical study of the theroy of water injection and the introduction of a bottoming steam engine cycle on the third stroke of a four cycle engine. This modified six cylinder diesel engine with precombuster has a bore of 3.710 inches piston diameter and a stroke of 3.937 inches. Assumed turbocharger pressure ratio of 3.0:1 and an engine cycle compression ratio of 25:1. Operating speed of 3750 RPM. Diesel fuel used C₁₀H₂₂ with a LHV of 19,192 BTU/lb. Intake Valve Open at 48 degrees with fuel injected at 167 degrees. Shower Head Area of 0.032 square inches. Exhaust valve open at 308 degrees. The analysis was based on the assumption that the duration of the fuel injection is proportional to the fuel-air ratio. The start of water injection has been delayed by a prescribed amount to allow ignition of the fuel to start in the reformer allowing an increase in reformer gas temperature before water vaporization starts, thereby, preventing the flame from being extinguished. All of the fuel and practically all of the water has been injected by the time the crankshaft has reached 250 degrees at the fuel-air ratio of 1.00.
Cond. 1 Engine operating at 3750 RPM with a fuel air ratio of 0.55 and no water introduced into the cycle.
Cond. 2 Engine operating at 3750 RPM with a fuel air ratio of 0.55 and a fuel water ratio of 1.2 with water introduced into the cycle at top dead center.
Cond. 3 Engine operating at 3750 RPM with a fuel air ratio of 0.55 and a fuel water ratio of 1.2 with water introduced at the intercooler discharge, reducing the air inlet temperature to 147.6 degrees.
Cond. 4 Engine operating as a steam engine with steam introduced at 2000 PSI and 1000 degrees F. at top dead center.
Cond. 5 Predicted output conditions by the addition of engine Cond. 2 and Cond. 4.

| Cond | HPD | HPS | SFC | DME | TEFF | TMAX | TEX |
|---|---|---|---|---|---|---|---|
| 1 | 230.2 | | .4411 | 46.2 | 30.1 | 3903 | 2765 |
| 2 | 304.0 | | .3301 | 45.7 | 40.2 | 3805 | 2688 |
| 3 | 313.3 | | .3268 | 46.6 | 40.6 | 4274 | 3159 |
| 4 | | 323.7 | 0 | 46.6 | 45.7 | 2000 | 300 |
| 5 | 313.3 | 323.7 | .1599 | 46.6 | | | 1494 |

HPD = Horse Power Diesel
HPS = Horse Power Steam
SFC = Specific Fuel Consumption LB/HP Hr
DME = Air or Steam Flow LB/Min
TEFF = Thermal Efficiency
TMAX = Maximum Cycle Temperature Degrees F.
Tex = Exhaust Temperature Degrees F.

### CONCLUSIONS, RAMIFICATIONS AND SCOPE

The object of this patent is to provide an environmentally acceptable CI engine, operating on a low cost safer diesel fuel, that provides excellent vehicular operational characteristics and has eliminated undesirable pollutants, including noise and smell from the exhaust. By reforming the fuel, particulates, smoke, hydrocarbons and aldehydes which are responsible for the obnoxious smell, are eliminated from the exhaust. Exhaust cooling will allow for condensation and recycling of the water while it eliminates the carbon monoxide and nitrous oxides from the exhaust. An important ramification of this cooling is reflected in the design of the turbocharger turbine. An undesirable characteristic of a turbocharged vehicular engine is the response rate of the turbocharger, which is directly related to the mass polar moment of inertia of the turbocharger rotor. By cooling the exhaust, the requirement for a high temperature material for the turbine has been eliminated. Both turbine and compressor can be fabricated from a composite material, significantly reducing the polar moment of inertia and at the same time reducing the cost and significantly improving the response rate of the engine.

A second ramification of the proposed cycle is the possibility of designing the turbocharger with additional flow through the compressor to supply bleed air for an air cycle airconditioning system. More energy is available in the exhaust than is required for the turbocharger. To bring this air to the desired temperature level for airconditioning, it can be used to power a tip turbine driving the cooling fan and/or a generator for the electrical system.

A third ramification of the proposed design will be its ability to operate on a wide variety of fuels including kerosene, distillate fuel oils, Jet A, Jet B, JP-3, JP-4, JP-5, CITE, methanol and alcohol.

A fourth ramification will be the surplus condensed distilled water that will be available each time the tank is refilled. The water used for the steam cycle is reuseable indefinately and the additional water from the products of combustion is continually added.

While my above description contains many specificities, these should not be construed as limitations on the scope of the invention, but rather as an amplification of one perferred embodiment thereof. Many other variations are possible. For example, the military and commercial fan and jet engines are major (possibly a major) contributors to the particulates found in the air of the large metropolitan communities. A comparison of the amount of jet fuel burned will confirm this statement. The reformer principle of this invention can be directly applied to the combustion section of these engines. A large contributor to the carbon monoxide and nitrous oxides are the afterburning military jets and the commercial transport engines. The temperature of the exhaust is a direct measure of the relative amount of both carbon monoxide and nitrous oxides, and the afterburner temperatures exceed 3540° F. which is well above the temperatures where a siginificant amount of disassociation does occur.

Accordingly, the scope of the invention should be determined not by the embodiment(s) illustrated, but by the appended claims and their legal equivalents.

I make the following three independent claims:

1. An electronically controlled dual flow (water or steam and fuel) for the CI engine or a complex spark plug and water nozzle for the SI engines.

2. A water cooled heatexchanger (boiler) between the engine exhaust and the and the turbocharger which is capable of recovering the waste heat in the exhaust and is then used for the steam cycle of the compound engine.

3. The design of a condenser, installed at the discharge of the turbochager turbine capable of removing the heat of vaporization from the exhaust by passing ambient ram air over the offset cooling fins. The condensed water is collected and pumped into the dual fuel tank.
